(19) United States
(12) Patent Application Publication
(10) Pub. No.: US 2014/0042355 A1
(43) Pub. Date: Feb. 13, 2014

(54) Thermal Insulation with Entangled Particulate Units having Non-Integer Dimensionality

(71) Applicants: David V. Tsu, Auburn Hills, MI (US); Robert J. Kopf, Royal Oak, MI (US); David Jablonski, Waterford, MI (US); Scott F. Jenney, Bloomfield Hills, MI (US)

(72) Inventors: David V. Tsu, Auburn Hills, MI (US); Robert J. Kopf, Royal Oak, MI (US); David Jablonski, Waterford, MI (US); Scott F. Jenney, Bloomfield Hills, MI (US)

(21) Appl. No.: 13/584,602

(22) Filed: Aug. 13, 2012

(51) Int. Cl. E04B 1/78; C08K 7/02; C08K 7/08; C08K 7/06

(52) U.S. Cl. 252/62; 428/401; 428/389

(57) ABSTRACT

A synthetic insulation material that rivals and surpasses down in performance without suffering degradation in insulating power over time. The material is an aggregate of particulate units that have a fractal-like geometric configuration. The geometric configuration includes non-integer dimensionality that promotes physical entanglements of the particulate units. The physical entanglements impart a high frictional resistance to slippage of the particulate units to maintain loft over time by inhibiting the settling of particulate units upon compression. The geometric configuration further includes aspects of self-similarity. The particulate units are formed from a material that efficiently scatters thermal radiation. The combination of high loft and efficient scattering of thermal radiation minimizes heat loss resulting from conduction and radiation, leads to a superior material for thermal insulation, has excellent health characteristics for human and the environment, and exhibits excellent long term life cycle performance.

### FIELD OF INVENTION

This invention relates to a material for thermal insulation. More particularly, this invention provides an insulating material that exhibits high loft and efficient scattering of thermal radiation. Most particularly, this invention provides an insulating material composed of particulate units with (1) physical entanglements to maintain loft, (2) non-integer dimensionality to efficiently fill space, and (3) a material of construction that efficiently scatters thermal radiation.

### BACKGROUND OF THE INVENTION

Nature has provided its creatures a very diverse set of strategies to keep warm. While marine mammals depend solely on fat-based blubber, land-based mammals also use fat, but also rely on their fur (or hair). In contrast, winged creatures that are especially adapted to life in cold climates (e.g., geese and ducks), have developed a strategy based on very light weight down insulation.

The usual explanation of how down functions is based on its fluffiness, which is said to enable down to provide insulation by “trapping warm pockets of air”. The logic underlying this explanation is that the thermal conductivity of air is fairly low. Since thermal conductivity and thermal resistivity are inversely related, air can be equivalently viewed as a medium having a fairly high thermal resistance. In the building industry, thermal resistance is often quantified with the familiar “R-value” rating. The R-value of a material quantifies the thermal resistance of a 1-inch thick layer of the material. For air, the R-value is about 5.8° F.-ft²-Hr/Btu-inch. Table 1 shows a comparison of the R-value (per inch of thickness) of air with other common insulation materials used in the building industry. Table 1 shows that the R-value of air compares favorably to the leading commercial insulation materials.

TABLE 1

| Type | R/inch |
|---|---|
| Fiber glass | 3.0 to 3.5 |
| Cellulose | 3.7 |
| Expanded polystyrene | 4.0 |
| Extruded polystyrene | 4.9 to 5.0 |
| Polyisocyanurate | 6.0 to 6.4 |
| Air | 5.8 |
| Goose Down | 3.5 |

Although a high R-value is desirable for good thermal insulation, the customary R-value characterizes only one of the three primary mechanisms of heat transfer: conduction. In addition to conduction, heat transfer can occur from a warm environment to a cold environment through the mechanisms of radiation and convection.

Convective heat transfer occurs upon physical motion or transport of warm material to colder surroundings. There are two classes of convection, often referred to as (i) forced, and (ii) natural. A common example of forced convective heat transfer is heat loss due to drafts through doors or windows of a house. Wind is another example that leads to the “wind chill factor”. This does not apply to our discussion of insulation because all insulation materials tend to be covered by some sort of wind barrier. For this, birds use their outer feathers, jackets use the outer cloth, and houses use their outer siding. Even in the absence of any wind, temperature differences can lead to natural convection. However, due to air's finite viscosity, convective motion is strongly suppressed by the presence of the insulation's support structure. Since convective transport requires transfer of mass and since the insulation materials of greatest commercial interest are primarily intended to fill the internal space of a mechanically intact volume (e.g. the space between walls or the interior of a garment), the mechanism of convection is insignificant relative to conduction and radiation in most insulation applications.

Radiative heat transfer, however, is often significant and occurs via the emission of thermal radiation from objects by virtue of their temperature. Since the intensity of thermal radiation increases strongly with increasing temperature, the radiative mechanism leads to a net transfer of heat from warm objects to cold objects without a transfer of mass, nor does it require a transfer medium. Indeed, the radiative mechanism even applies in vacuums (unlike either conduction or convection). For objects at room temperature, thermal radiation is primarily in the infrared (IR) portion of the electromagnetic spectrum, having its peak intensity at a wavelength near 10 microns. Detection of infrared radiation is the basis of most thermal imaging systems.

The significance of radiative heat transfer explains why air alone, despite its high conductive R-value, is a poor material for thermal insulation. It turns out that air is almost completely transparent to infrared radiation, which means that heat loss via radiative transport is highly efficient through air. Even though air is resistant to conductive heat transfer, the highly efficient radiative heat transport through air makes air an overall poor thermal insulator.

Mathematically, the total thermal resistance R_{Total} of an insulation material can be expressed

$$\frac{1}{{R}_{Total}} = \frac{1}{{R}_{conduction}} + \frac{1}{{R}_{radiation}} + \frac{1}{{R}_{convection}} \qquad ( 1 )$$

where R_{conduction}, R_{radiation}, and R_{convection} correspond to the resistances of the insulation material to the conductive, radiative, and convective mechanisms of heat transfer, respectively.

In situations where convection is negligible, Eq. (1) simplifies to

$$\frac{1}{{R}_{Total}} = \frac{1}{{R}_{conduction}} + \frac{1}{{R}_{radiation}} \qquad ( 2 )$$

In a medium like air, where the conductive resistance is much larger than the radiative resistance, Eq. (2) becomes

$$\frac{1}{{R}_{Total}} = \frac{1}{{R}_{radiation}} \qquad ( 3 )$$

Eq. (3) indicates that the high conductive resistance of air provides little benefit to the overall performance of air as a thermal insulation material due to the high efficiency of radiative heat transport through air, where R_{radiation} would be small. Eq. (2) makes it evident that when considering an optimal insulation design, one simply cannot separate the loft's trapping of air with the loft's trapping of thermal radiation. Systems based on high thermal radiation trapping can have poor overall performance if the loft is not properly designed to trap air.

The above analysis reveals that the standard explanation of how insulation functions (i.e., by trapping warm air) is only half the story. The half that is typically ignored is the need to trap infrared photons to minimize the radiative contribution to heat loss. Down is an effective insulation material only in part because its structure creates loft, where the loft traps air to minimize conductive heat transfer. This structure also acts to highly impede convection. Equally important is the fact that the fibrous framework structure responsible for the loft of down performs yet another duty: namely it effectively scatters infrared radiation. As the radiation is scattered, its original outward path (from warm environment to cold surroundings) is severely disrupted and the radiation is substantially returned to the originating warm environment. The efficient scattering by the structure of down acts to trap infrared radiation and prevent its escape to the surroundings. Without a mechanism for trapping thermal radiation, down would be an ineffective thermal insulation material, despite its high loft, because of the high transparency of the air trapped in the structure of down to infrared radiation.

This scattering and trapping of infrared radiation is what allows R_{radiation} in Eq. (3) to markedly increase. The radiative resistance of down can be estimated to be R_{radiative}=8.8 using Eq. (2) with R_{Total}=3.5 and R_{conductive}=5.8. A remarkable feature of down is that the fibrous structure responsible for the efficient scattering of thermal radiation and high radiative resistance accounts for only about 1% of its volume. (Trapped air accounts for the remaining 99% of the volume and is the primary determinant of R_{conductive}.) This means that down has the further advantage of being a lightweight material. Down manifests the true optimization of thermal insulation by nature, i.e., optimal trapping of air, with high radiation trapping using a minimal amount of material.

Although down has many advantages as a thermal insulation material, it suffers from a few drawbacks. First, down is a natural material that is only available from living creatures. The special care and attention needed to harvest down tends to limit the supply of down and increase cost. Second, down has a tendency to irreversibly lose its loft when it gets wet and this greatly reduces its insulation capabilities. Third, down is difficult to launder and difficult to dry. Fourth, many people have allergies to down.

Because of the disadvantages of down, a number of synthetic alternatives have been developed. Synthetic insulation is commonly in the form of foam or fibers and has the advantage of being easy to manufacture and low in cost. Some synthetic insulation (e.g., those based on polymer fibers) can also be laundered easily and tends to retain some of its insulating qualities when it gets wet. The main disadvantage of synthetic insulation is that it tends to lose its loft when it gets compressed. Frequent compression tends to cause synthetic fibers to settle or break, resulting in a loss of loft and an accompanying contraction in the volume of air pockets. Loss of air pockets between fibers leads to a greater surface area of contact between fibers and an accompanying increase in heat loss due to conduction through the fibers (i.e., heat is transferred from fiber to fiber by direct contact of the fibers). Settling of fibers also creates a headspace filled with air that leads to efficient heat loss due to radiative transport where there is no longer any fiber material to act as infrared scattering centers. Foams tend to mechanically deform and lose loft over time when compressed repeatedly. The loss of loft is difficult to reverse and leads to a consistent degradation in the insulating power of synthetic foams and fibers over time. Synthetic insulation is also heavier than down and cannot match the performance of down in terms of its insulating performance per unit mass of the active material.

There is thus a need for a synthetic insulation material that is readily manufactured and possesses the attributes of down while maintaining the advantages of current synthetic fibers.

### SUMMARY OF THE INVENTION

This invention provides a synthetic insulation material that rivals down in performance and even surpasses it without suffering degradation in insulating power over time. Moreover, it will not degrade when subjected to water, it will naturally resist mold growth, it will not damage human health or the environment with volatile organic compounds, and it will have excellent life cycle performance by being intrinsically recyclable. The new material includes an aggregate of particulate units that may have a fractal, fractal-like or related geometric configuration. The geometric configuration includes non-integer dimensionality that promotes physical entanglements of the particulate units. The physical entanglements impart a high frictional resistance to slippage of the particulate units and thus function to maintain the loft of the insulation material by inhibiting the settling of particulate units upon compression. Instead of slipping and settling, the geometric configuration insures that the instant particulate units become interlocked or entangled when compressed. The force of compression is stored as potential energy from bending of the particulate units from the point of entanglement or contact and this energy is available to restore loft when the force is removed.

The geometric configuration may further include aspects of self-similarity, in which geometric features on microscopic length scales mirror geometric features on macroscopic length scales. Self-similarity may aid in establishing entanglements between particulate units and may also lead to efficient filling of space to provide a lightweight insulation material.

The particulate units are formed from a material that efficiently scatters or reflects thermal radiation. The combination of high loft and efficient scattering or reflection of thermal radiation minimizes heat loss resulting from both conduction and radiation and leads to a superior material for thermal insulation.

The particulate units may be made from inorganic and/or organic materials that are natural and/or synthetic and that have been processed to a geometric configuration having non-integer dimensionality and/or self-similarity. Typical materials include natural or synthetic oxides, nitrides, minerals, carbons, plastics, metals or metal alloys, and high refractive index materials. The particulate units may be composites that include a base material and a surface coating, where the surface coating increases the efficiency of scattering or reflection of thermal or infrared radiation. In one embodiment, the surface coating is a metal and the base material is a plastic, a foam, a synthetic or natural fiber and may include down.

The invention further extends to mixtures of the instant particulate units with other insulation materials. The particulate units may be combined with down or other natural materials and/or with fiberglass or synthetic materials (including foams and fibers) to form a composite insulation material with controllable physical and thermal attributes.

The insulation material of this invention may be used as a fill material in buildings (e.g. insulation of walls, attics, ceilings, floors), in garments and other accessories (e.g. coats, footwear, hats, gloves, insulated curtains), and in outdoor gear (e.g. coolers, water bottles, tents, sleeping bags). The insulation material may also be used in sound-proofing or electrical insulation applications.

The insulation material may be formed by processes such as (physical or laser) cutting, scribing, grinding, stamping, and pulverizing to achieve particulate units that are dimensionally engineered to achieve non-integer dimensionality and advantageous loft characteristics.

The instant insulation material incorporates geometric and material features that provide loft to create air space to minimize heat losses due to conductive processes while simultaneously inhibiting radiative heat loss by insuring efficient scattering or reflection of thermal radiation. The instant material unites the advantages of down and existing synthetic insulation in a new material that provides one or more of the following advantages: high loft, durability of loft, high mechanical resilience, resistance to settling, water resistant, manufacturability, easy care, and biological inertness. This insulating material is designed to meet the most stringent performance metrics by the U.S. Environmental Protection Agency, especially in terms of its high R-value performance, its resistance to mold and to water damage, its lack of volatile organic content, and its very favorable life cycle performance in terms of its excellent long term impact on the environment due to its intrinsic ability to recycle and to reuse.

### BRIEF DESCRIPTION OF THE DRAWING

FIG. 1 depicts five classes of particulate units for insulation materials (tape measure in inches).

FIG. 2 is a scanned image of Class-A “Small” particulate units (shown on ¼ inch grid). This class of particulate units is random in shape and about ½ inch in dimension (or less).

FIG. 3 is a scanned image of Class-B “Linear” particulate units (shown on ¼ inch grid). Each particulate unit consists of one branch that is substantially linear.

FIG. 4 is a scanned image of Class-C “Non-Linear-2” particulate units (shown on ¼ inch grid). Each particulate unit consists of two branches, some of which take the shape of a “Y”, others resemble “V”, and others are like “U” or “II”. A few Linear particulate units are also present.

FIG. 5 is a scanned image of Class-D “Non-Linear-n” particulate units (shown on ¼ inch grid). Each particulate unit consists of multiple branches (n>2). Two particulate units are shown taped to the grid paper.

FIG. 6 is a scanned image of Class-E “Big” particulate units (on ¼ inch grid). Each particulate unit is generally broad, as opposed to a slender 1D shape, and is closer to being true 2D objects, with weak to no branching character.

FIG. 7 shows a microscope view (40×) of the edges of selected particulate units.

FIG. 8 shows average values of loft for down and representative samples of each type of particulate unit. Averages were obtained from ten measurements.

FIG. 9 shows an exponential relationship between loft and dimensionality for particulate units of Type (A), Type (B), and down.

FIG. 10 shows an estimation of the dimensionality of particulate units of Type (C) and Type (D) using the exponential relationship depicted in FIG. 9. Results are presented in units of in³/oz and cm³/g.

FIG. 11 shows the dependence of volumetric dimensionality (βd) on dimensionality (d) for a series of particulate units.

FIG. 12 shows the dependence of volumetric efficiency (βd/3) on dimensionality (d) for a series of particulate units.

FIG. 13 shows a measurement apparatus for determining the IR transmittance of particulate units in accordance with the instant invention.

FIG. 14 shows calibration for converting the output of an IR camera to an IR transmittance. The solid line represents a calibration relative to the open beam and the dashed line represents a calibration relative to the bare film substrate window.

FIG. 15 shows the transmission of IR radiation through one mono-layer of particulate units in accordance with the instant invention.

FIG. 16 shows the dependence of monolayer IR transmission on loft for representative types of particulate units in accordance with the instant invention.

FIG. 17 shows total IR blocking through one mono-layer of representative types of particulate units in accordance with the instant invention.

### DETAILED DESCRIPTION OF THE ILLUSTRATED EMBODIMENTS

Although this invention will be described in terms of certain preferred embodiments, other embodiments that are apparent to those of ordinary skill in the art, including embodiments that do not provide all of the benefits and features set forth herein and including embodiments that provide positive benefits for high-volume manufacturing, are also within the scope of this invention. Accordingly, the scope of the invention is defined only by reference to the appended claims.

The instant insulation material is an aggregate of particulate units. As described more fully hereinbelow, the particulate units are dimensionally engineered to achieve a geometric configuration that restores loft when the insulation material is compressed or crushed. The geometric configuration may have non-integer dimensionality and may exhibit a high degree of self-similarity. The geometric configuration and/or material of construction of the particulate units may also facilitate scattering of thermal radiation to inhibit heat loss through radiative transport.

An important feature of an insulation material is loft. Loft refers to the capacity of an insulation material, or particulate units thereof, to adopt an expanded, porous configuration. The porous configuration provides a solid framework with internal cavities that can be occupied by another material. Preferably, the material that occupies the internal cavities has high resistance to heat transfer. Although condensed phases may occupy the internal cavities, gases are generally preferred because gases are lightweight and tend to have high resistance to conductive heat transfer. Air is a common gas used to occupy the internal cavities of a porous insulation material. As noted hereinabove, however, air is highly transparent to thermal radiation, so the framework structure that encapsulates the air must efficiently scatter thermal radiation to insure good insulation characteristics. In addition to providing loft, the geometric configuration of the framework structure of the instant materials inhibits heat loss through radiative processes by facilitating the scattering or reflection of thermal radiation.

The creation of loft in an insulation material ultimately requires forming a three-dimensional framework structure. The desired physical attributes of the framework structure include (1) the ability to efficiently fill three-dimensional space and (2) mechanical resilience. Efficient filling of three-dimensional space requires the framework structure to have high porosity (or void volume) and minimal material volume. Minimal material volume suppresses thermal conduction through the framework structure and provides the benefit of a lightweight insulation material. Mechanical resilience refers to the capacity of the framework structure to recover its original shape following compression or deformation. A common defect of prior art synthetic insulation materials is loss of loft due to settling or breaking of fibers or other particulate units over time due to compression or intrinsic weight. The framework structure of the particulate units of the instant insulation materials is geometrically configured to resist settling and promote an elastic response to compression to maintain the integrity of loft over time.

Proper design of the geometric configuration of the particulate units is needed to create and maintain loft. Geometric features at both macroscopic and microscopic length scales contribute to loft and its durability. By macroscopic length scale, we generally refer to geometric features that can be discerned with the unaided eye. Microscopic features are finer than macroscopic features. The geometric configuration of the instant particulate units has been designed to provide a “high friction” framework structure that resists translational relaxation when subject to an external compression force. Instead of causing motion of particulate units relative to each other, the application of compressive force to the particulate units establishes or strengthens entanglements between units. The aggregate framework structure does not relax appreciably through translation of particulate units past each other and instead responds to compressive force through the creation of interlocks between particulate units. The geometric configuration of the particulate units includes branching and features that impart roughness to the surface and edges. The roughness may include features that are jagged, hooked, barbed, branched, or otherwise irregular. As compressive force is applied and the particulate units shift position and impinge on each other, the branching and/or surface roughness causes the particulate units to interlock or entangle, thereby inhibiting relative translational motion (slippage) of the particulate units. Continued compression of interlocked particulate units bends, strains or otherwise deforms the units, but the entanglements between the units inhibit slippage and prevent settling. Instead of inducing slippage, an applied compressive force is stored in the bonds of interlocked particles and is manifested as an internal deformation or rearrangement of particulate units. Since the energy of the compressive force is stored as a form of internal energy, it becomes a form of potential energy that is available to restore the framework structure to its original, high loft configuration when the force is removed. The tendency of the instant particulate units to resist slippage and relative translation motion may be referred to herein as “friction”. The instant particulate units may be said to have high friction.

In prior art fiber-based insulation materials, in contrast, the surfaces of individual fibers are smooth and the fibers are prone to relative translational motion (slippage) upon application of a compressive force. As a result, the compressive force is dissipated as an irreversible settling of fibers instead of as a recoverable form of stored internal energy. Whereas the instant branched and surficially-rough particulate units have high friction (resistance to slippage), the smooth fibers of prior art materials have low friction and readily slide past each other upon application of a compressive force.

The settling of fibers leads to a loss of loft and a degradation of insulation performance Insulation performance suffers when fibers settle because (1) thermal conduction through the fibers becomes more efficient due to the increased area of contact between fibers that arises as fibers settle and (2) radiative heat loss increases as the overhead space vacated by settled fibers becomes occupied purely with infrared-transparent air.

The high frictional state of the particulate units prevents slippage of the units past one another and promotes dissipation of external compressive energy in the form of a configurational potential energy of the aggregate of particulate units that make up the insulation material. The configurational potential energy may be manifested as a bending, twisting, local compression, stretching or other deformation of individual particulate units or a plurality of particulate units. Inclusion of branching and/or surface or edge roughness promotes an interlocked arrangement of particulate units that prevents slippage and enables storage of compressive energy as a recoverable form of potential energy upon relaxation of the compressive force. The number of branches and the length of individual branches also influences the tendency of particulate units to form geometric entanglements that facilitate preservation of loft. Longer branches and greater branching numbers, in particular, promote greater entanglements. Recovery of the framework structure upon relaxation of the compressive force restores loft and preserves the insulation capacity of the material.

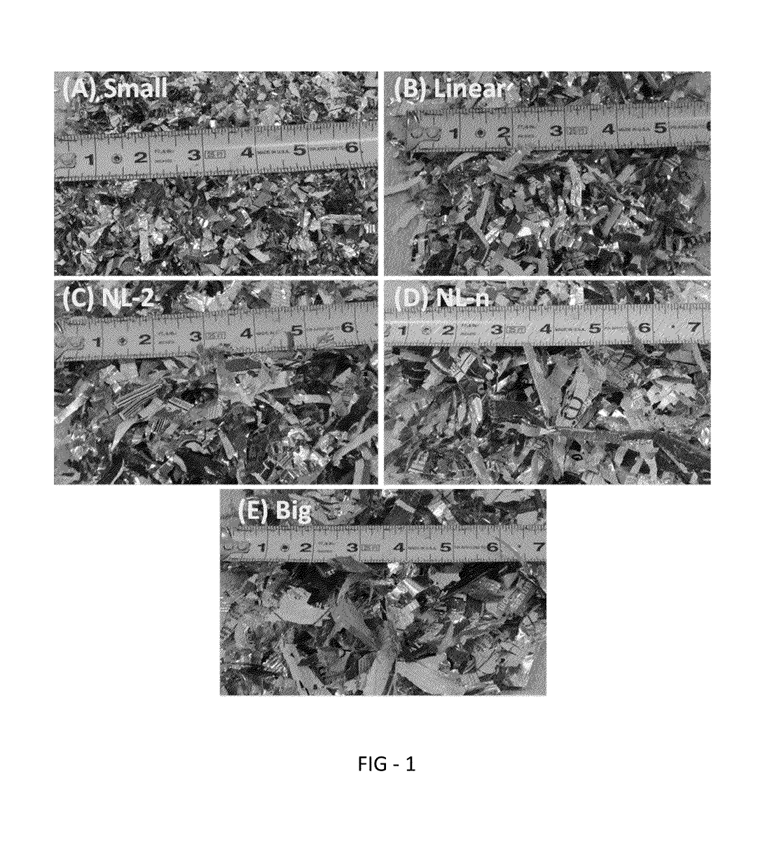

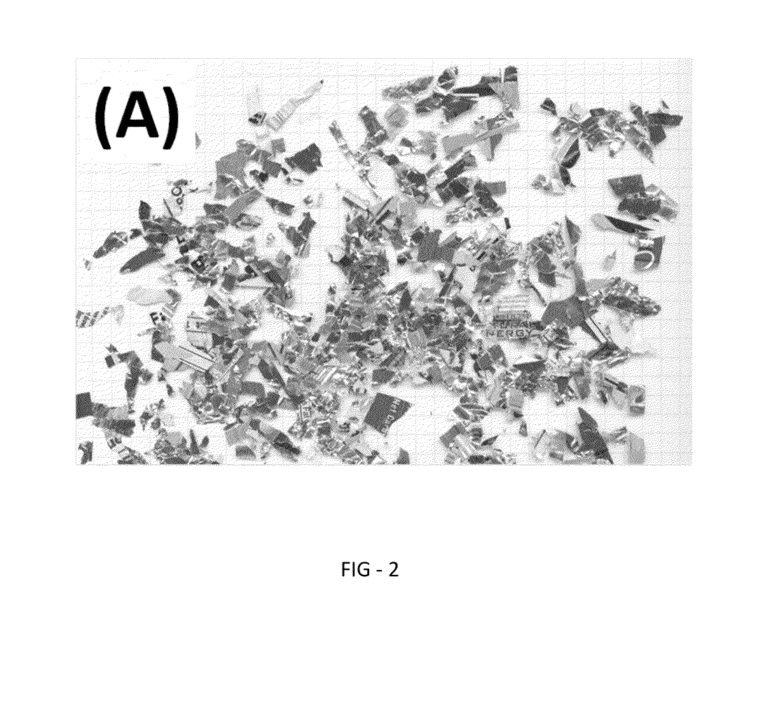

The geometric configurations of the instant particulate units include macroscopic and microscopic features. On the macroscopic level, five general types of particulate units can be identified. Illustrative examples of each type are presented in FIGS. 1-6 and selected features of each type are summarized in Table 2. The material selected for the illustrative examples consisted of an aluminum film supported by a polymer (e.g., polypropylene) substrate base and the particulate units were formed by a mechanical cutting process into the shapes shown in FIGS. 1-6. The images shown in FIGS. 2-6 show an example of each type of particulate unit as viewed by an office scanner and include background graph paper with ¼-inch grid spacing to indicate relative scale.

The description of particulate units that follows makes reference to “branches”. As used herein, a single line defines one branch (see, for example, particulate units of Type (B)). Even if a particulate unit cannot be represented as a line, however, it may still consist of a single branch within the meaning of the definition used herein. The shape of particulate units of Type (A) or Type (E), for example, might be described as a square, rectangle, triangle, trapezoid, circle, or other shape and may nonetheless be regarded as having a single branch. A particulate unit having only one branch may be referred to as “unbranched”. Branching occurs when the shape of the particulate unit is notched or bifurcated in some manner. Branching is the feature that fundamentally defines the two non-linear types of particulate units (Types (C) and (D)). Type (C) units have two branches, while Type (D) units have an arbitrary number (n) of branches, where n is greater than two and has no upper limit.

In Table 2, aspect ratio refers to the length:width ratio of a particulate unit. Although typical branch lengths are presented in Table 2 for each type of particulate unit, the length scales of the instant invention are not limited to any particular physical lengths. The extent (i.e., number) of branching, length of branches and the relative aspect ratio of particulate units contribute separately and in combination to the benefits afforded by the instant invention. Below we describe the applicability of the concept of non-integer (i.e., rational or irrational number) dimensionality to the description of the geometric configuration of the instant particulate units. Geometric descriptions based on non-integer dimensionality are largely equivalent to descriptions in terms of branching and aspect ratios and may provide a more convenient classification of the different types of particulate units.

TABLE 2
Macroscopic Classification of Particulate Units

| | | Typical | | | |
|---|---|---|---|---|---|
| | | Branch | Typical | | |
| | | Aspect | branch | No. | Relative |
| Type | Description | Ratio | Length (in.) | Branches | Loft |
| (A) Small | Symmetrical | <4:1 | 0.0 to <0.5 | 1 | 1 |
| | Low aspect ratio | | | | |
| (B) Linear | Substantially linear | >4:1 | 0.0 to >2.0 | 1 | 2 |
| | High aspect ratio | | | | |
| (C) Non-Linear-2 | Two (2) primary branches | >4:1 | 0.0 to >2.0 | 2 | 3 |
| (D) Non-Linear-n | Multiple (n) branches | <4:1 | 0.0 to >2.0 | >2 | 4 |
| | | >4:1 | | | |
| (E) Big | Symmetrical | <4:1 | ≧0.5 | 1 | 3 |
| | Low aspect ratio | | | | |

Type (A) particulate units have one branch and may be referred to as “small” units. As seen in FIG. 2, Type (A) units are clearly not lines or extended linear objects, but rather are more reminiscent of points and tend to be irregular. Because they are not linear, Type (A) units have modest aspect ratios of less than 4:1 (<4:1). Particulate units shaped as squares, circles and triangles, for example, have 1:1 aspect ratios.

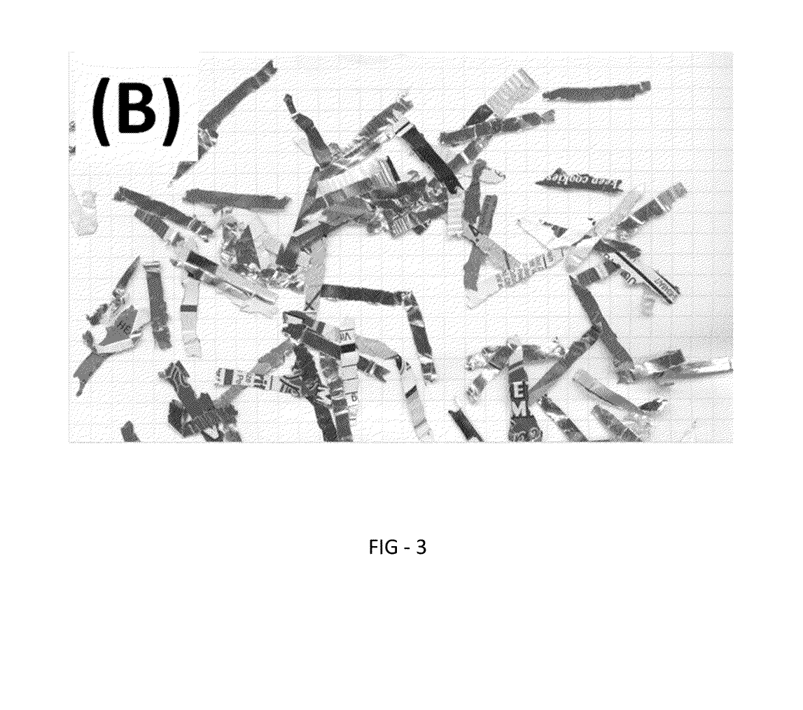

Type (B) particulate units are depicted in FIG. 3 and are most readily described as one-dimensional strips having one branch. Type (B) units may be referred to as “linear” units and are characterized by high aspect ratios, usually >4:1 and frequently >8:1. It is important to note that for Type (B) particulate units, we do not restrict the aspect ratio, which may exceed 8:1 by considerable amounts. Type (B) particulate units encompass long, unbranched fibers. It is also important to note that the single branch characteristic of Type (B) units need not be uniformly straight and may instead curve or bend as indicated in FIG. 3.

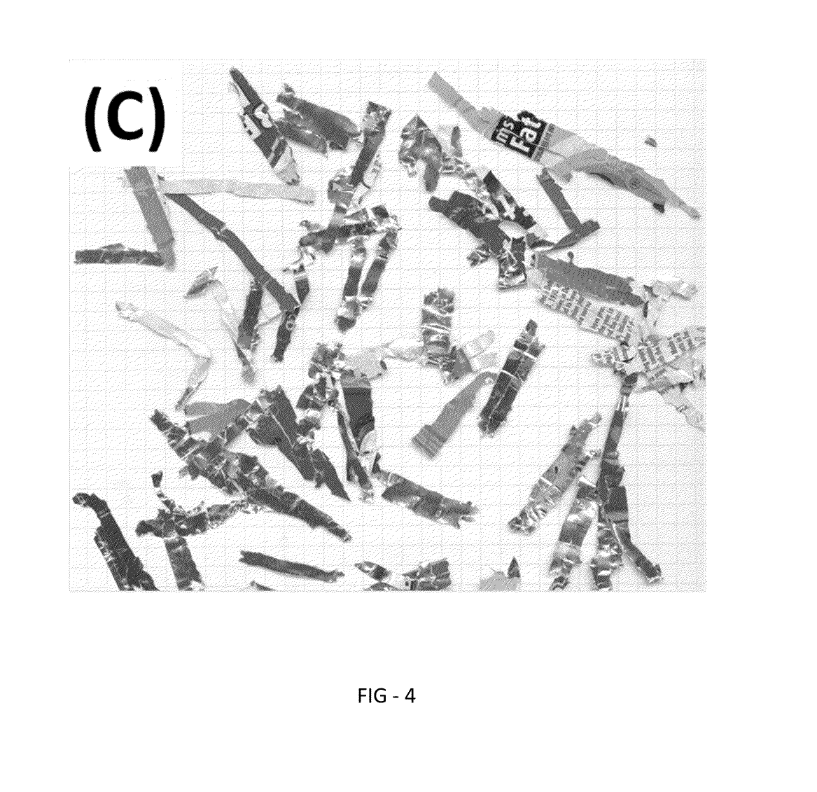

Type (C) particulate units have two branches and, as shown in FIG. 4, do not appear linear to the eye. Type (C) particulate units may accordingly be referred to as “non-linear-2” units. Simple examples of Type (C) particulate units include shapes that resemble the letters “V”, “L”, “T”, “Y”, or “U”. As is evident in FIG. 4, however, Type (C) particulate units may deviate significantly from these simple letter shape descriptions. In some cases, for example, the two branches may be nearly parallel (e.g. “II”). The different branches of Type (C) units may be similar or differ in aspect ratio, physical dimensions and/or curvature. One branch, for example, may be wider (or longer) than the other branch and the width of either or both branches may vary along the length of the branch.

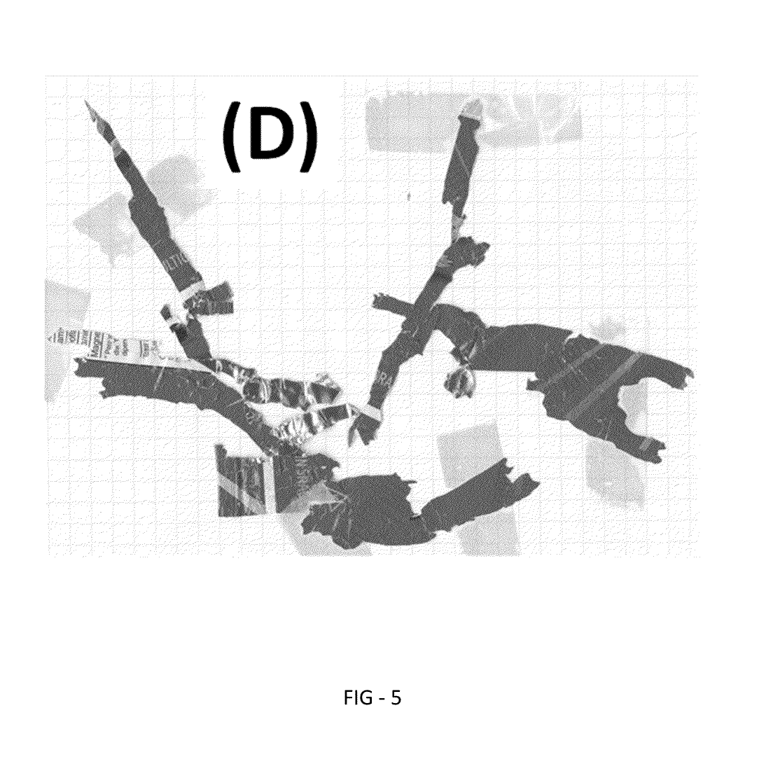

Particulate units of Type (D) are more complicated in geometric configuration and include multiple branches (FIG. 5). As for Type (C), Type (D) particulates units are non-linear in shape. Since Type (D) units may potentially include an arbitrary number of branches, they may be referred to as “non-linear-n” units, where n is greater than 2. The branches of Type (D) units may be similar or differ in aspect ratio, physical dimension (e.g. length), curvature, etc. Type (D) particulate units encompass complex shapes and may include branches within branches, which is an aspect of self-similarity and fractal-like characteristics. In one embodiment, the instant Type (D) particulate units may approach the fractal structure of down and yet remain wholly synthetic and readily manufacturable.

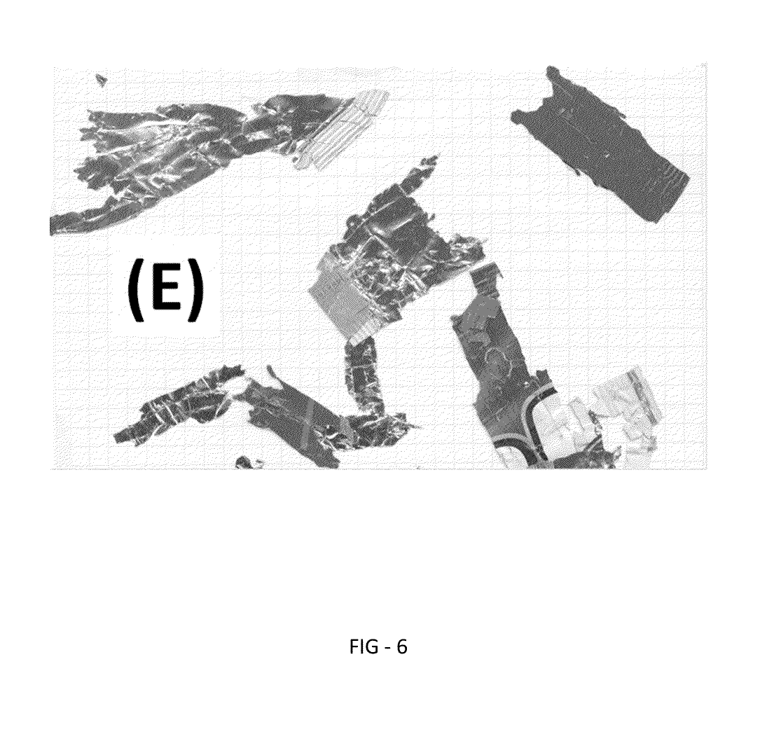

Type (E) particulate units (FIG. 6) are a larger version of Type (A) units and substantially lack branching. Type (E) particulate units may be referred to as “big” units. Like Type (A) units, Type (E) units have low aspect ratios (<4:1). The main difference between Type (A) units and Type (E) units is size. The small size of Type (A) units imparts more point-like characteristics, while the larger size of Type (E) units makes them more two-dimensional or plate-like in nature.

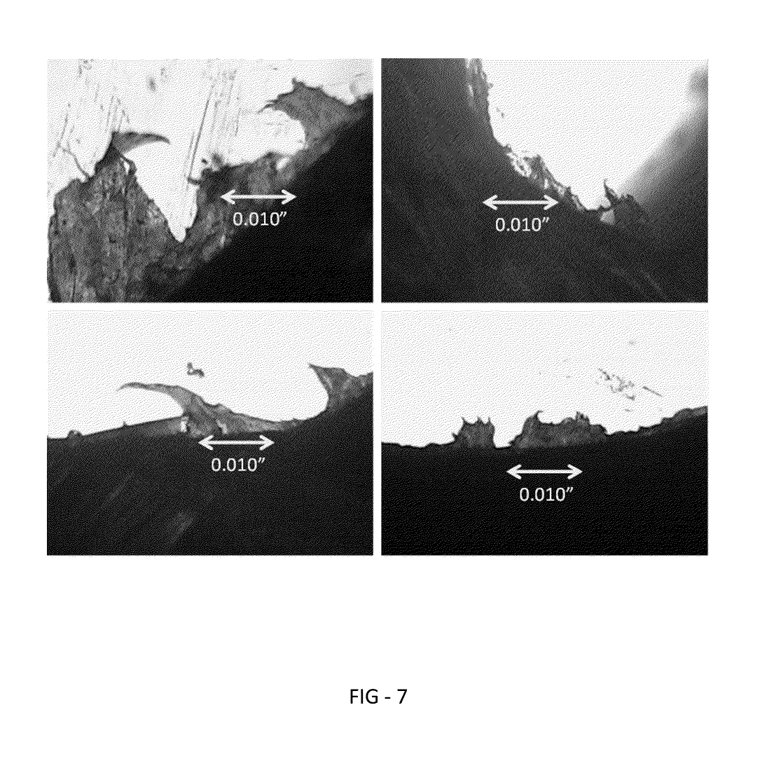

An important feature of the instant particulate units on both macroscopic and microscopic levels is roughness or irregularity at edges and/or surfaces. Roughness or irregularity is a common feature of each of the five types of particulate units discussed hereinabove. The edges and surfaces of the instant particulate units are not necessarily flat, straight, or smooth, but may be “ragged”, uneven, or non-uniform instead. The edges and surfaces of the instant particulate units may include hooks, jags, protrusions, barbs, points, spikes, zigzags, indentations, depressions, teeth, and other shape irregularities that render the units non-smooth. While these are clearly evident on the macroscopic scale (FIGS. 2 through 6), this same description holds on the microscopic scale. An illustration of surface or edge irregularities of randomly selected particulate units in accordance with the instant invention is shown in FIG. 7 for the microscopic scale. The similarity in the descriptions on both the macroscopic and microscopic scales demonstrates a measure of self-similarity.

As noted hereinabove, the irregular edges and surfaces have important consequences in establishing loft and preserving or restoring loft upon removal of a compressive force. Restoration of the original volume of the insulation material from a compressed state can only proceed if there is a mechanism for mechanical resilience that provides a restoring force when an external compressive force is removed. The irregularities at the surfaces and edges cause the instant particulate units to interlock or bind when compressed to provide resistance to slippage and thereby create a mechanism for storing the force of compression as a recoverable form of potential energy that acts to restore loft when the compressive force is removed. As noted hereinabove, if the geometric configuration of particulate units is such that the units slide past each other upon compression, the units will settle into a low energy, relaxed state that lacks a mechanism for driving recovery of volume when the compressive force is removed. Inclusion of edge or surface irregularities in the instant particulate units overcomes this deficiency of prior art insulation materials. Branching also facilitates entanglements between particulate units that assist in restoring loft of the instant insulation materials upon removal of a compressive force.

Self-similarity is a further feature of some embodiments of the instant invention. Self-similarity generally refers to similarity of geometric features at the microscopic and macroscopic length scales. Self-similarity imparts fractal characteristics to the instant particulate units. An example of self-similarity may be seen in a comparison of FIG. 3 and FIG. 7. FIG. 3 presents a macroscopic view of Type (B) units and shows curvature and bending on a macroscopic level that resembles those exhibited on the microscopic level shown in FIG. 7. Both the macroscopic shape and the microscopic shape are seen to include zigzag-like features. Comparisons of the macroscopic depictions shown in FIGS. 2-6 with FIG. 7 reveals that similar analogies hold for other forms of surface or edge irregularity and for the other types of particulate units described hereinabove. The various microscopic edge and surface irregularities (zigzags, points, hooks, indentations, steps, protrusions, etc.) have macroscopic analogs. Thus, regardless of scale, the edges have similar types of irregular patterns and behaviors.

Embodiments of the instant insulation material have at least two distinct properties that reveal independent aspects of fractal behavior: (i) self-similarity on the microscopic and macroscopic length scales of surface and edge irregularities of the particulate units and (ii) complexity of branching on the macroscopic scale that approaches that of down.

We next determine the loft of representative samples of each type of particulate unit within the scope of the instant invention, describe the dimensionality of the instant particulate units and discuss the relationship between dimensionality and loft.

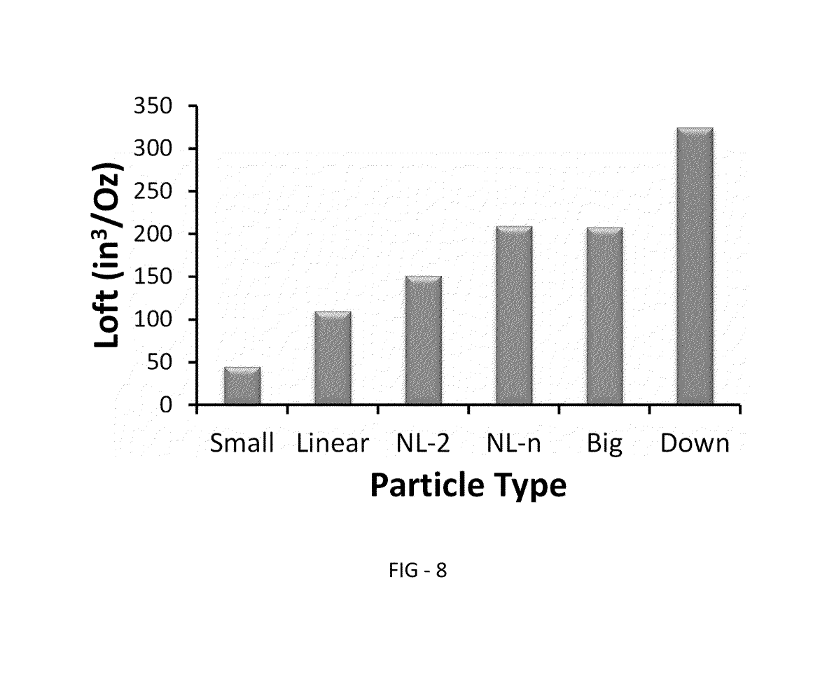

The loft of insulation is normally quantified as an inverse density and expressed as the volume of insulation material per unit mass. The insulation industry generally uses units of cubic inches per ounce of material (in³/oz). The following procedure was used to determine the loft of representative samples of each type of particulate unit: (1) a small cardboard box of known weight and volume was filled with a representative sample of each type of particulate unit (see FIG. 1 for depictions of each type of particulate unit) and the box was gently tapped as it was filled to promote even filling to the top; (2) the filled box was weighed; (3) the weight of the empty box was subtracted to determine the net weight of the particulate unit; and (4) the loft of the sample was computed by dividing the volume of the empty box by the net weight of the particulate units. The measurement was repeated ten times for each type of particulate unit and the average loft determination for each type of particulate unit is reported in FIG. 8.

We observed a steady increase in loft from about 45 in³/oz for Type A (“small”) particulates units up to about 210 in³/oz for Type D (“non-linear n”) particulate units and with no further increase for Type E (“big”) particulate units. We believe that the apparently high loft of these Type E particulate units is an inaccurate account of their true loft and reflects their overall large physical sizes, which begin to approach the size of the measurement box. In other words, these “big” units do not homogeneously fill the measurement box. FIG. 8 also shows the measured result for down (taken from a winter coat) at 325 in³/oz. FIG. 8 shows a clear progression of increasing loft for particulate units of Types A-D, where Type D particulate units more effectively fill space for the same mass of material.

Dimensionality is one way to characterize the loft of the instant insulation materials. Since the features of the individual particulate units that make up a given sample of material may vary, dimensionality is best understood as an average over the aggregate of particulate units contained in a sample. Down is known in the art to have a dimensionality (D) of about D=1.68. Linear particles (Type B particulate units) define a dimensionality D=1.0. Small particles (Type A particulate units) have D<1.0, where the dimensionality depends on the actual shape characteristics of the particles. True point objects have D=0. However, since the small Type A particulate units shown herein are not true point particle objects, D>0. Based on the features of Type A particulate units shown in FIGS. 1 and 2, we estimate D˜0.4. The plate-like features of Type E particulate units indicates that they are predominantly two-dimensional objects and thus have D=2.

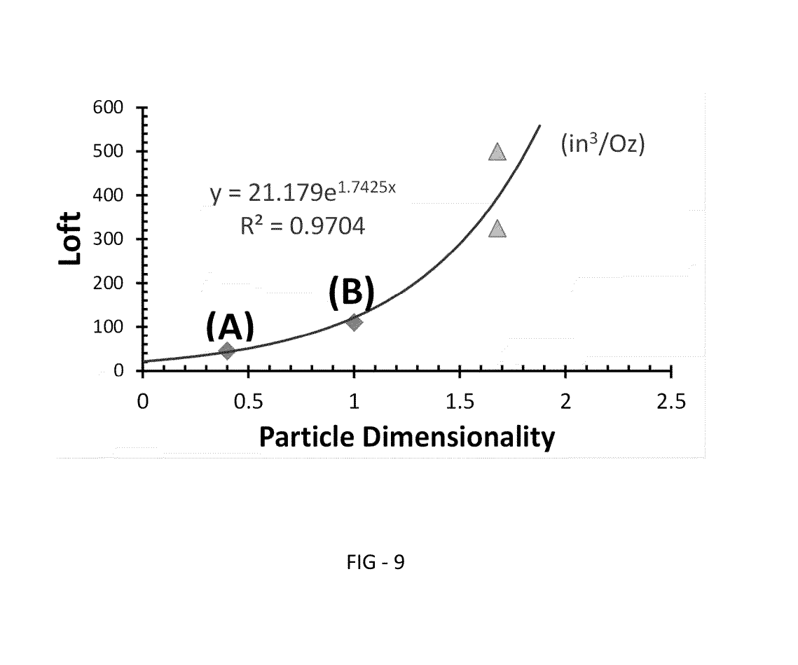

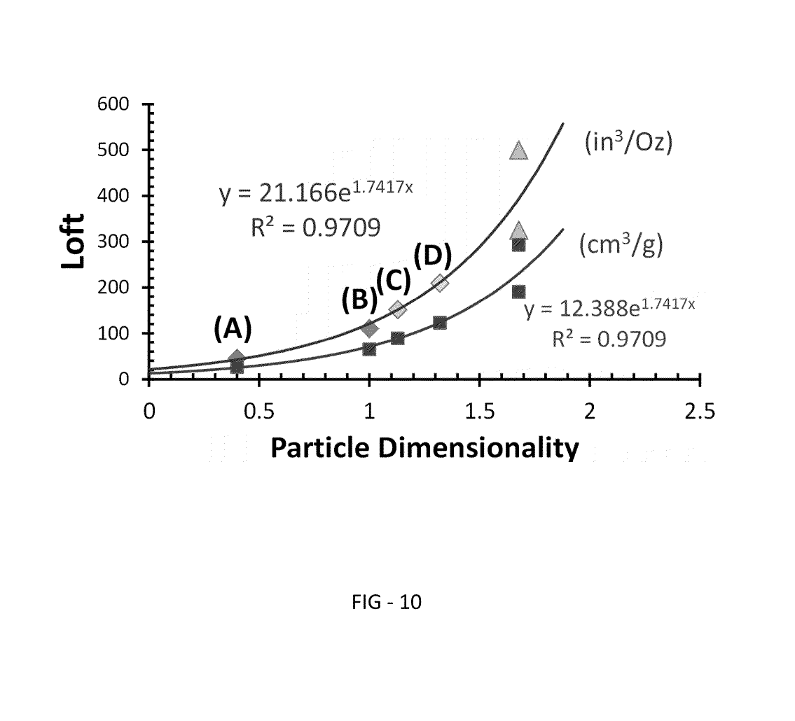

Because of the more pronounced structural irregularity of particulates units of Types C and D, estimation of dimensionality is more difficult. Instead, we resort to a mathematical approach based on loft to infer the dimensionality of Type C and Type D particulate units. FIG. 9 shows a mathematical model based on an exponential relationship between loft and known dimensionality for particulate units of Type A, Type B and down. Data points at two loft values are included for down: one at our measured value (325 in³/oz) and a second at a value typical for actual performance (500 in³/oz). The solid line shows an exponential fit and the results indicates that he quality of the fit is very high (R²=0.97). From the correlation and measured values of loft, we can estimate an effective dimensionality D for particulate units of Types C and D. The results are shown in FIG. 10 and summarized in Table 3. The dimensionalities estimated for particulate units of Types C and D are 1.13 and 1.32, respectively.

TABLE 3
Dimensionality and Volumetric Efficiency of Particulate Units

| | | Effective | | |
|---|---|---|---|---|
| Type | Description | Dimensionality | Vol. eff. (%) | Comment |
| A | Small | 0.40 | 25.6 | Not quite point |
| | | | | objects |
| B | Linear | 1.00 | 55.7 | A line defines 1D |
| C | NL-2 | 1.13 | 66.3 | Estimated |
| D | NL-n | 1.32 | 77.1 | Estimated |
| E | Big | 2.00 | 76.9 | Fills 2D space |
| | Down | 1.68 | 99.7 | Literature value |

From the results, we observed that the dimensionality of a particulate unit is closely associated with its degree of branching. Loft systematically increases from particulate units of Types B, C, and D as the branching increases. The highest loft is observed for Type D, the particulate unit with the most extensive branching of the representative samples described herein. The trend in loft observed in the progression over particulate units of Types B, C, and D indicates that the complexity of branching is evolving toward that of down. Over the progression, the instant particulate units are increasingly developing the self-similarity and fractal-like features responsible for the superior performance of down as an insulation material.

The exponential fit used to model the relationship between loft and dimensionality has the form:

Loft=αe^{βD} (4)

and includes two model parameters of interest, the pre-factor (α) and the exponential factor (β). To understand the significance of the parameters, we need to factor out physical effects from arbitrary effects associated with the choice of unit system. In FIG. 10, the data shown in FIG. 9 are reproduced in two unit systems. The upper curve shows the correlation in units of in³/oz and the lower curve shows the correlation in units of cm³/g. Exponential fits in both unit systems are shown. The fits reveal that the pre-factor (α) depends on the choice of unit system, while the exponential factor (β) does not. The analysis indicates that the value of the pre-factor (α) is a consequence of an arbitrary choice of units and the exponential factor (β) is a manifestation of an underlying physical phenomenon related to dimensionality and the filling of three-dimensional space.

It is of interest that an exponential function should apparently well describe the relationship between loft and dimensionality. Exponential functions usually describe systems that self-reinforce. For example, the exponential rise in pressure with depth in the atmosphere arises because we must add the incremental weights of each elemental volume of air to all elements below. Analogously, each element of increasing dimensionality increases the total ability to fill three dimensional space. This is consistent with our description that higher dimensionality self-reinforces to produce greater entanglement, and this ultimately promotes greater volume filling efficiencies.

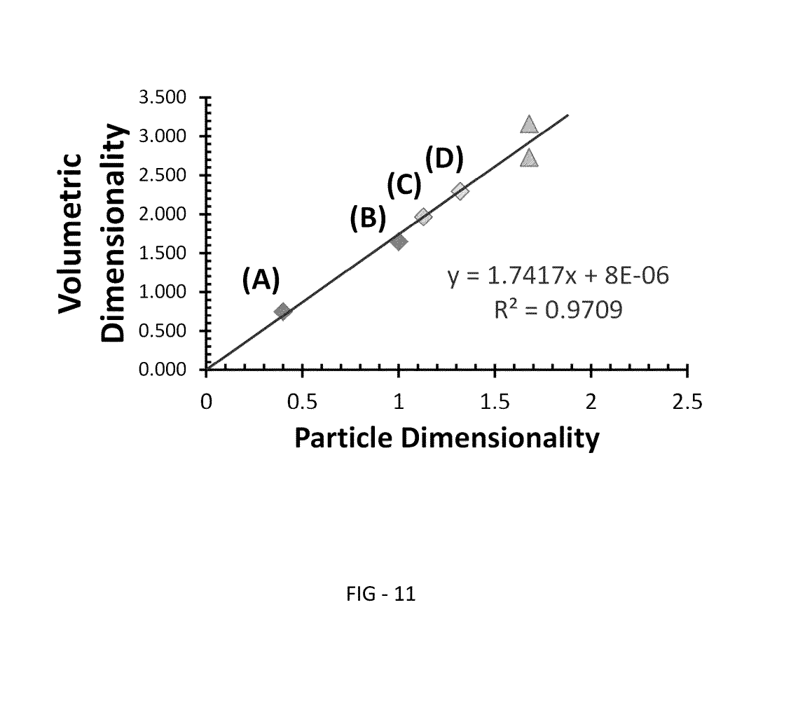

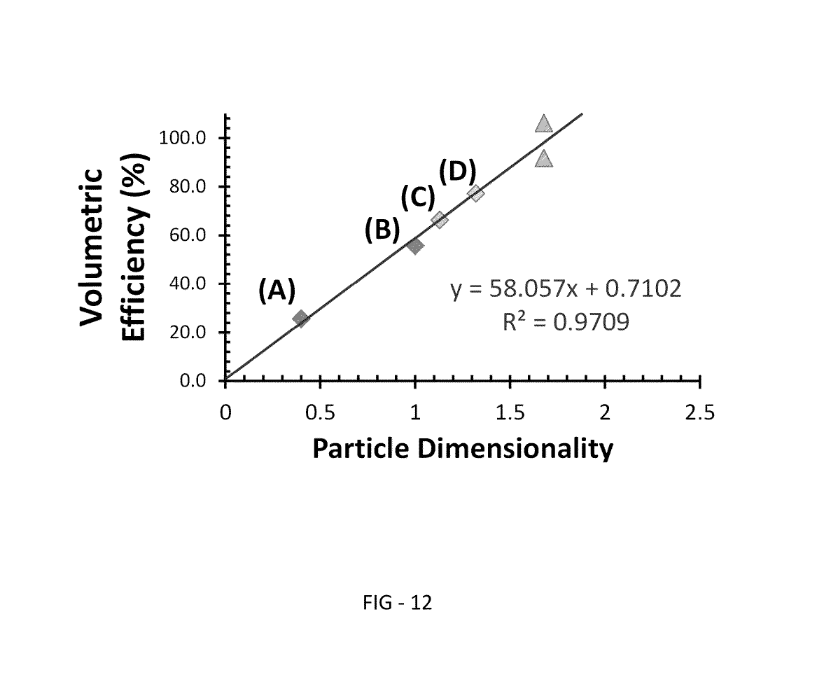

We define the volumetric dimensionality of a particulate unit to be a product of the exponential factor (β) and the dimensionality D. FIG. 11 shows the dependence of volumetric dimensionality on dimensionality for down and particulate units of Types A, B, C, and D. The plot shows that as the particle's dimensionality approaches zero, the volumetric dimensionality also approaches zero and that as dimensionality approaches the value of 1.68 for down, the volumetric dimensionality approaches 3. This result indicates that true point objects (D=0) cannot fill three-dimensional space, while down very effectively fills three-dimensional space. In this sense, the product 13D provides a measure of the efficiency of a particulate unit to fill three-dimensional space and is thus properly regarded as a volumetric dimensionality. We extend the concept of volumetric dimensionality in FIG. 12, where we normalize volumetric dimensionality to three-dimensional space by dividing by three and convert to a percentage to define a volumetric efficiency. The volumetric dimensionalities of down and the particulate units of the instant invention are included in Table 3, where the value for down is taken as an average of the two data points. Volumetric efficiency can be interpreted in terms of the ease with which three-dimensional space can be filled by a particulate unit of a particular dimensionality. Particulate units with high volumetric efficiency are able to fill a given volume of three dimensional space with less material than particulate units of low volumetric efficiency.

The results show that down has the highest volumetric efficiency and that the volumetric efficiency of the particulate units of the instant invention increases as the degree of branching increases. Relative to the 100% volumetric efficiency of down, one-dimensional objects (Type B particulate units) are only 56% efficient. The low volumetric efficiency of one-dimensional objects explains why insulation materials based on elongated fibers (e.g. fiberglass) have limited insulation capabilities. By comparison, particulate units of Type D have a volumetric efficiency of 77% and are far more effective at filling three-dimensional space than conventional fiber-based insulation materials. The analysis shows not only that the loft of one-dimensional fibers is poor, but also shows that to achieve the same volumetric filling of three dimensional space as the instant Type D (non-linear n) particulate unit, 38% more of the fiber material would be needed. This difference in the mass of material needed to achieve comparable filling of three-dimensional space represents enormous inefficiency (in terms of both material and energy) in the production and use of fiberglass insulation.

As a nation, we must recognize that much of our insulation infrastructure is fundamentally flawed in that far more energy and material resources are needed to produce insulation than is necessary. The instant invention addresses this deficiency by providing a more intelligent design of insulation materials based on the principles of non-integer dimensionality. Biological survival necessarily entails reckoning with circumstances of limited resources and biological creatures have survived by achieving high levels of insulating performance at a minimum cost to the creature's resource and energy budget. Through many millions of years of evolution, nature has created down, which has the perfectly optimized dimensionality to fill three-dimensional space. Through particulate units of non-integer dimensionality, the instant invention effectively mimics down but does so in a way that is compatible with large scale manufacturing processes. Based on the principles elucidated herein, particulate units having non-integer dimensionality can be produced through ripping, tearing, cutting, grinding, stamping, scribing, and pulverizing processes and can be accomplished by physical or laser methods.

In one embodiment, particulate units of the instant invention have a dimensionality of less than or equal to 1.6. In another embodiment, particulate units of the instant invention have a dimensionality greater than 1.0 and less than 1.6. In still another embodiment, particulate units of the instant invention have a dimensionality of greater than 1.1 and less than 1.6. In yet another embodiment, particulate units of the instant invention have a dimensionality of greater than 1.2 and less than 1.6. In a further embodiment, particulate units of the instant invention have a dimensionality of greater than 1.3 and less than 1.6. In still a further embodiment, particulate units of the instant invention have a dimensionality of greater than 1.1 and less than 1.5. In still a further embodiment, particulate units of the instant invention have a dimensionality of greater than 1.2 and less than 1.5. Particulate units within the foregoing dimensionality ranges may have two or more branches. In another embodiment, particulate units within the foregoing dimensionality ranges may have three or more branches. In a further embodiment, particulate units within the foregoing dimensionality ranges may have four or more branches.

In one embodiment, the particulate units of the instant invention have an aspect ratio of 2:1 or greater. In another embodiment, the particulate units of the instant invention have an aspect ratio of 2:1 or greater and two or more branches. In another embodiment, the particulate units of the instant invention have an aspect ratio of 2:1 or greater and three or more branches. In another embodiment, the particulate units of the instant invention have an aspect ratio of 2:1 or greater and four or more branches. In another embodiment, the particulate units of the instant invention have an aspect ratio of 2:1 or less. In another embodiment, the particulate units of the instant invention have an aspect ratio of 2:1 or less and two or more branches. In another embodiment, the particulate units of the instant invention have an aspect ratio of 2:1 or less and three or more branches. In another embodiment, the particulate units of the instant invention have an aspect ratio of 2:1 or less and four or more branches.

In one embodiment, the particulate units of the instant invention have an aspect ratio of 4:1 or greater. In another embodiment, the particulate units of the instant invention have an aspect ratio of 4:1 or greater and two or more branches. In another embodiment, the particulate units of the instant invention have an aspect ratio of 4:1 or greater and three or more branches. In another embodiment, the particulate units of the instant invention have an aspect ratio of 4:1 or greater and four or more branches. In another embodiment, the particulate units of the instant invention have an aspect ratio of 4:1 or less. In another embodiment, the particulate units of the instant invention have an aspect ratio of 4:1 or less and two or more branches. In another embodiment, the particulate units of the instant invention have an aspect ratio of 4:1 or less and three or more branches. In another embodiment, the particulate units of the instant invention have an aspect ratio of 4:1 or less and four or more branches.

In one embodiment, branches of the instant particulate units have a length of at least 0.25 inch. In a further embodiment, the branches of the instant particulate units have a length of at least 0.5 inch. In another embodiment, the branches of the instant particulate units have a length of at least 1.0 inches. In still another embodiment, the branches of the instant particulate units have a length of at least 2.0 inches. In yet another embodiment the branches of the instant particulate units have a length of at least 4.0 inches. In yet another embodiment the branches of the instant particulate units have a length of at least 6.0 inches.

In one embodiment, branches of the instant particulate units have a uniform cross-section. In another embodiment, branches of the instant particulate units have a non-uniform cross-section. In still another embodiment, the non-uniform branches include tapered regions.

In one embodiment, the particulate units of the instant invention have a volumetric efficiency of at least 60%. In another embodiment, the particulate units of the instant invention have a volumetric efficiency of at least 70%.

The materials selected to form particulate units in accordance with the instant invention are designed to efficiently scatter and/or reflect infrared radiation to minimize heat loss through radiative transport mechanism. In one embodiment, the material is typically an inorganic material, such as SiO₂, metal oxide or other oxide, transparent conductive oxide, nitride, carbide, boride or mineral. These materials typically possess heteropolar bonds that exhibit strong resonant interactions with infrared radiation to provide efficient scattering of infrared radiation. In another embodiment, the material may also be a metal or metal alloy. Metals and metal alloys possess free carriers that strongly interact with and scatter or reflect infrared radiation. In one embodiment, the metal or metal alloy is resistant to oxidation. Suitable metals include Al, Pt, Au, Ag, and Cu. In a further embodiment, the material is a high refractive index material such as diamond or a semiconductor (e.g. column IV semiconductor or a III-V semiconductor).

Materials in accordance with the instant invention also include composite materials. Composite materials include layered materials that include a substrate material and a coating material. The substrate material is a base material and may be a plastic or organic material. Substrate materials include, but are not limited to, polycarbonate (PC), polyurethanes, polyethylene (PE), polypropylene (PP), polyvinylchloride (PVC), and polyethyleneterephthalate (PET). The coating material is on one or more of the exposed surfaces of the substrate material and is the portion of the composite material that receives infrared radiation and efficiently scatters or reflects it. The coating material may be one of the single materials mentioned hereinabove. In one embodiment, the composite material includes an aluminum coating on a plastic substrate.

The plurality of particulate units that are combined to produce an insulation material according to the instant invention may include particulate units that differ in material of construction and/or dimensionality. Particulate units formed from composite and non-composite materials, for example, may be combined to produce an insulation material. Particulate units with low and high dimensionality may also be combined. The invention further extends to insulation materials formed from a combination of particulate units in accordance with the instant invention and other materials. The materials combined with the instant particulate units may be natural or synthetic, organic or inorganic, and may have integer or non-integer dimensionality. Representative natural or synthetic materials that may be combined with the instant particulate units include other forms of insulation, foams, fibers, down, plastics, polycarbonate, polypropylene, polyethylene, polystyrene, polyethyleneterephthalate, cellulose, polyisocyanurate, wool, rock wool, fiberglass, polymer fibers, cotton, down, fur, hair and silk

The infrared blocking capability of the particulate units described hereinabove in connection with FIGS. 1-7 was investigated through measurements of thermal infrared transmission. As a general principle, radiation incident on a surface may be reflected, scattered, or transmitted. Radiation that is scattered or reflected is effectively blocked, while radiation that is transmitted represents a loss that impairs the insulating power of the material. By measuring the fraction of thermal radiation that is transmitted, the combined fraction that is reflected and scattered can be determined from the following equation:

R_{Total}=1−T (5)

where T is the transmitted fraction of thermal radiation and R_{Total} is the thermal infrared blocking power. R_{Total} includes the combined fraction of scattered and reflected thermal radiation. In this description, we assume that that the absorption of infrared energy is minimal.

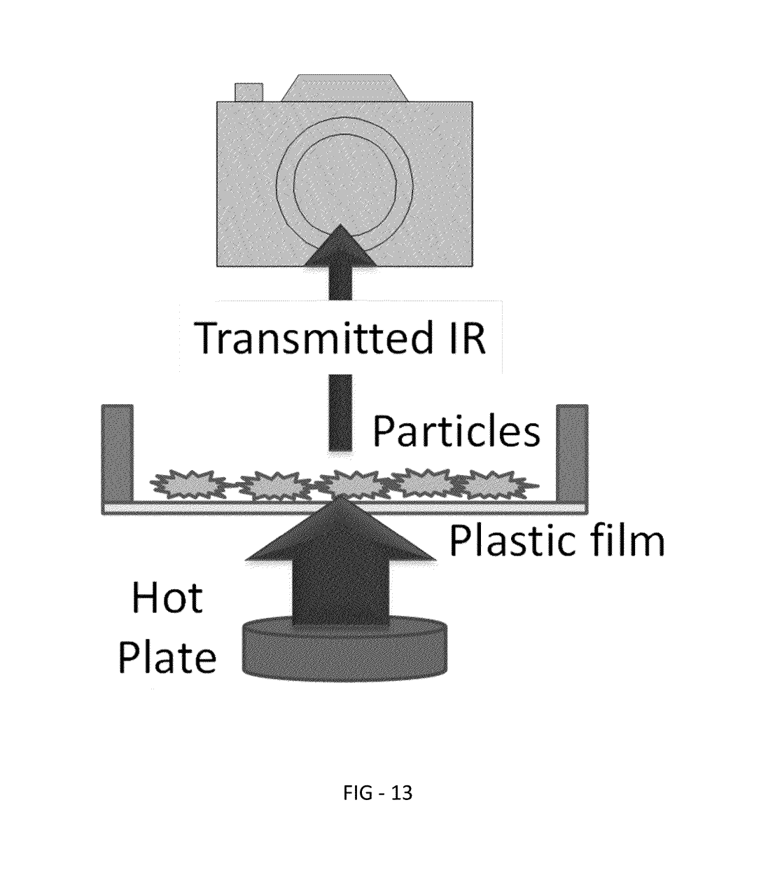

FIG. 13 shows the experimental setup used to measure IR transmission. A hot plate is used as a source of thermal IR radiation and an infrared camera is used to detect transmitted thermal IR energy. Samples of particulate units are placed on a thin bare plastic film (about 0.5 mil thick) that is placed between the hot plate and the infrared camera. This plastic film supports the samples and acts as a transparent IR window. While transparent, it too has some basic reflectance related to the fact that its refractive index is greater than 1.0, which in no way is associated with the samples to be placed on top of it. This basic reflectance will contribute to a small reduction of the overall transmission signal. Below, we describe how this “window signal” is accounted for.

The IR detector of the infrared camera integrates the signal over a wide cross-section of the insulation material and determines an average result over a plurality of particulate units. The infrared camera receives the thermal IR energy transmitted through the plastic window film and the insulation material and processes it to produce an equivalent temperature. In order to determine transmittance from the temperature output, we performed a calibration of the infrared camera to develop a correlation between changes in output temperature and changes in transmitted thermal IR energy. The principle underlying the calibration is that the IR camera interprets a reduction in infrared energy reaching it as a reduction in the temperature. The extent to which the temperature determined by the camera is reduced correlates with the reflection/scattering efficiency of the insulating material placed between the thermal IR source (hot plate) and the camera. If the insulating material scatters thermal IR radiation, less radiation is received at the camera and the temperature recorded by the camera is less than the temperature recorded in the absence of the insulating material. The more effectively the insulating material scatters or reflects, the greater the reduction in radiation received by the camera is and the greater the decrease in temperature output is.

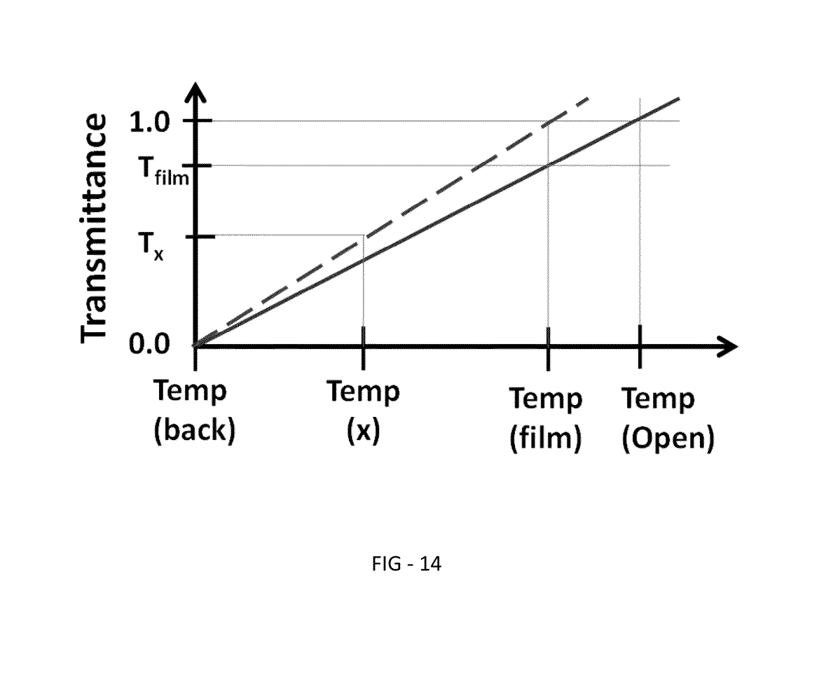

The calibration procedure is summarized in FIG. 14 and is based on a linear relationship of IR transmission with temperature. In the “open beam” configuration, there is no plastic window film between the hot plate and the camera. The calibration is based on an open beam temperature and a background temperature. The open beam temperature (averaged over the entire hot plate) defines a transmittance of 1.0 and represents temperature output of the infrared camera when directly exposed to the thermal IR source with no intervening materials. The background temperature is taken from a portion of the IR image of the camera that is far away from the hot plate and corresponds to the unheated ambient temperature. The background temperature represents the zero transmittance condition. The solid line shown in FIG. 14 defines a calibration for the open beam configuration that uses the open beam temperature and background temperature as endpoints. With this calibration, a reduction in output temperature of the infrared camera can be converted to a transmittance.

We continued by repeating the calibration after inserting a plastic window film between the hot place and infrared camera. As indicated hereinabove, a clear plastic window film was used to support samples of the instant insulation materials that were tested for IR transmittance. In order to properly determine the transmittance of the samples, it is necessary to account for the effect of the supporting plastic window film on the temperature recorded by the IR camera. The temperature measured for the plastic window film (without any insulation material on top) is shown in FIG. 14 and corresponds to an IR transmittance of 0.85 (as determined from the solid calibration line). 85% transmittance in the infrared is the expected transmittance for the material selected for the plastic film and this result validates the calibration procedure. Note that we have further tested this calibration process by including two and three plastic window films (i.e., instead of just one) and the reduction of temperature measured by the IR camera is in fine agreement with the expected drop in transmission of multiple window panes.

Since the insulation materials selected for testing were placed on the plastic window film, the open beam calibration (solid line) shown in FIG. 14 was normalized to redefine the transmittance value of 1.0 to correspond to the transmittance through the unloaded plastic window film. The renormalized calibration is shown as a dashed line in FIG. 14. By using the renormalized calibration, the reduction in IR transmittance of a sample insulation material can be determined directly without needing to account for the effect of the supporting plastic window film.

Measurements of infrared transmittance were conducted by applying a layer of each particulate unit on the plastic film in separate trials, reading the output of the infrared camera and converting it to a transmittance using the calibration. To properly compare particulate units of a different type, the same mass was used for the layer of each type of particulate unit. The mass selected for the layers was determined from particulate units of Type A. Since particulate units of Type A have the lowest dimensionality, they have the lowest loft of the samples described herein. To establish a mass for the trials, particulate units of Type A were applied to the plastic window film in the minimum amount needed to completely cover the plastic film and just block out light visible to the eye. The particulate units of Type A were arranged to prevent overlap and to avoid stacking so that single-layer coverage of the plastic film was achieved. This level of coverage may also be referred to herein as “monolayer” coverage of the plastic film. The mass of particulate units of Type A needed to achieve monolayer coverage was 3.3 g and this mass was defined as the reference mass for all samples of the experiment and was used to define monolayer coverage of particulate units of each type.

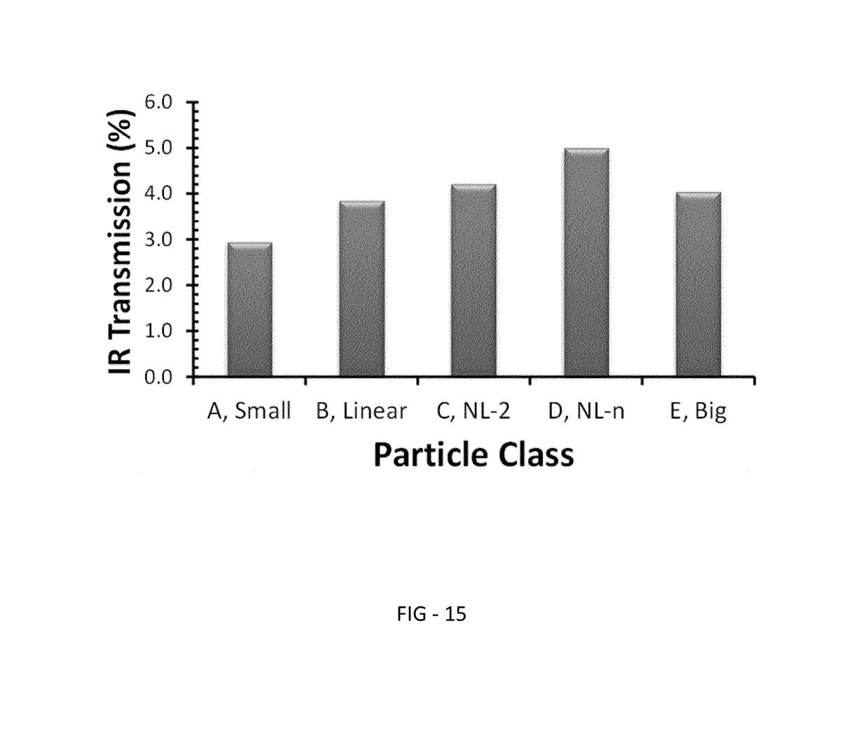

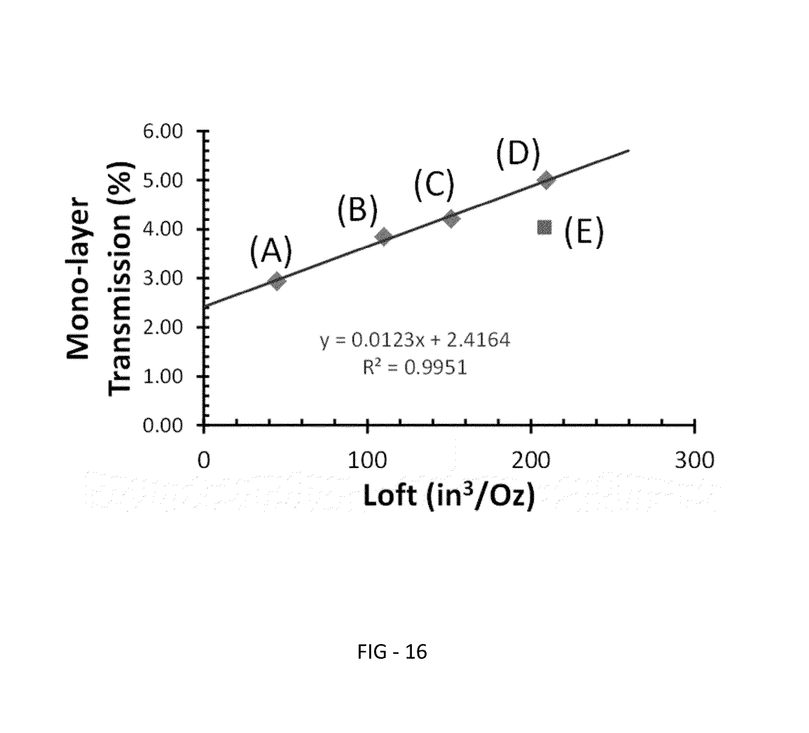

The results of the IR transmittance measurements are shown in FIG. 15. The variation in IR transmittance over the different types of particulate units was similar to the trend observed in loft (see FIG. 8). FIG. 16 shows the relationship between IR transmittance and loft directly. The data indicated that IR transmittance was smallest for Type A particulate units and progressively increased with increasing dimensionality through particulate units of Types B, C, and D. The increase in IR transmittance with increasing loft is a consequence of the more open, porous structure of particulate units having high dimensionality. Whereas particulate units of Type A cover the surface of the plastic film in a flat, uniform layer with few gaps, particulate units of higher dimensionality project away from the surface of the plastic film and include gaps in coverage of the plastic film that act as channels for the transmission of IR radiation. The exception to the linear relation between mono-layer transmission and loft is particulate units of Type E. The reduced IR transmittance for Type E materials is a consequence of the two-dimensional nature of Type E particulate units. Because of their plate-like configuration, monolayers of Type E particulate units are flat and cover the plastic film with few gaps.

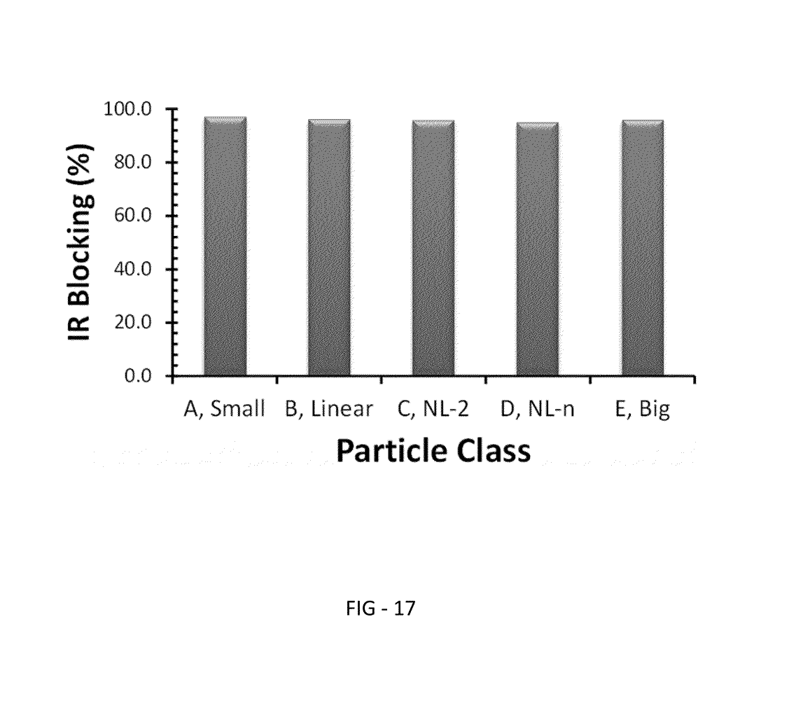

Although differences in the IR transmittance of the different types of particulate units were observed, these differences were small. To appreciate the insignificance of the difference, FIG. 17 converts the IR transmittance data shown in FIG. 16 to IR blocking efficiency using Eq. (5). FIG. 17 indicates that each type of particulate unit has mono-layer IR blocking well above 90%. The differences between particulate units becomes even smaller in practice because real-world applications of the materials will include significantly more than monolayer coverage. For most applications, we would expect an order of magnitude reduction in IR transmittance with each additional monolayer of material. As a result, insulation materials formed from the instant particulate units will exhibit high IR blocking efficiency in practical applications and any residual IR transmittance resulting from absorption by one layer and re-emission to other layers will be inconsequential relative to the highly efficient reflection and scattering characteristics of the instant particulate units.

The extremely low loss of thermal IR energy through the radiative transport mechanism means that its radiative resistance (i.e., R_{radiation}, see Eq. (2)) of the instant insulation materials will be very large in comparison to R_{conductive} of air. The insulating performance of the instant insulation materials will therefore be limited primarily by the thermal conduction of the air occupying the pores and openings established by the loft of the material. The instant non-integer dimensionality particulate units provide both high loft and excellent IR blocking efficiency and exhibit insulating characteristics limited not by IR transmittance, but by thermal conduction through the medium occupying the open spaces in the surrounding solid framework. At the same time, the high dimensionality of the particulate units enables us to construct the solid framework with the minimal amount of material. As a result, the instant insulation materials are extremely light in weight and exhibit minimal conduction through the solid framework. As described more fully hereinabove, the high dimensionality of the instant particulate units provides the further benefit of mechanical resiliency, which prevents deterioration of insulating power by preventing the settling of particulate units upon compression.

Those skilled in the art will appreciate that the methods and designs described above have additional applications and that the relevant applications are not limited to the illustrative examples described herein. The present invention may be embodied in other specific forms without departing from the essential characteristics or principles as described herein. The embodiments described above are to be considered in all respects as illustrative only and not restrictive in any manner upon the scope and practice of the invention. It is the following claims, including all equivalents, which define the true scope of the instant invention.

We claim:

1. An insulation material comprising a plurality of particulate units, said particulate units having a dimensionality greater than 1.0 and less than 1.6.

2. The insulation material of claim 1, wherein said dimensionality of said particulate units is greater than 1.1 and less than 1.6.

3. The insulation material of claim 1, wherein said dimensionality of said particulate units is greater than 1.2 and less than 1.5.

4. The insulation material of claim 1, wherein particulate units include two or more branches.

5. The insulation material of claim 4, wherein said two or more branches include jagged edges.

6. The insulation material of claim 4, wherein said branches have a non-uniform cross section.

7. The insulation material of claim 4, wherein the length of said branches is at least 0.25 inch.

8. The insulation material of claim 4, wherein the length of said branches is at least 0.5 inch.

9. The insulation material of claim 4, wherein the length of said branches is at least 1.0 inch.

10. The insulation material of claim 4, wherein the length of said branches is at least 2.0 inch.

11. The insulation material of claim 4, wherein the length of said branches is at least 4.0 inch.

12. The insulation material of claim 4, wherein the length of said branches is at least 6.0 inch.

13. The insulation material of claim 1, wherein particulate units include three or more branches.

14. The insulation material of claim 13, wherein said three or more branches include jagged edges.

15. The insulation material of claim 1, wherein particulate units include four or more branches.

16. The insulation material of claim 15, wherein said four or more branches include jagged edges.

17. The insulation material of claim 1, wherein said particulate units have an aspect ratio of 2:1 or greater.

18. The insulation material of claim 17, wherein said particulate units include two or more branches.

19. The insulation material of claim 17, wherein said particulate units include three or more branches.

20. The insulation material of claim 1, wherein said particulate units have an aspect ratio of 4:1 or greater.

21. The insulation material of claim 20, wherein said particulate units include two or more branches.

22. The insulation material of claim 21, wherein said particulate units include three or more branches.

23. The insulation material of claim 1, wherein said particulate units have a shape exhibiting self-similarity.

24. The insulation material of claim 1, wherein said particulate units comprise a metal.

25. The insulation material of claim 24, wherein said metal is aluminum.

26. The insulation material of claim 24, wherein said metal is in the form of a coating on a substrate material.

27. The insulation material of claim 26, wherein said substrate material comprises plastic or polymer.

28. The insulation material of claim 1, wherein said particulate units comprise an inorganic oxide or nitride.

29. The insulation material of claim 1, wherein said particulate units have a volumetric efficiency of at least 60%.

30. The insulation material of claim 1, wherein said particulate units have a volumetric efficiency of at least 70%.

31. The insulation material of claim 1, further comprising a synthetic or natural material.

32. The insulation material of claim 31, wherein said synthetic or natural material is selected from the group consisting of foam, rock wool, fiberglass, polymer fibers, cotton, wool and down.

33. The insulation material of claim 31, wherein said synthetic or natural material is in the form of a fiber.

34. The insulation material of claim 31, wherein said synthetic or natural material comprises polycarbonate, polypropylene, polyethylene, polyethyleneterephthalate, polystyrene, cellulose, polyisocyanurate, fur, hair or silk.
